(19) United States
(12) Patent Application Publication
(10) Pub. No.: US 2024/0231916 A9
(43) Pub. Date: Jul. 11, 2024

(54) METHOD, ELECTRONIC DEVICE, AND COMPUTER PROGRAM PRODUCT FOR ALLOCATING WORKLOAD

(71) Applicant: Dell Products L.P., Round Rock, TX (US)

(72) Inventors: Zijia Wang, WeiFang (CN); Yufeng Wang, Shanghai (CN); Chunxi Chen, Shanghai (CN); Zhen Jia, Shanghai (CN)

(21) Appl. No.: 17/989,344

(22) Filed: Nov. 17, 2022

(30) Foreign Application Priority Data
Oct. 21, 2022 (CN) 202211294804.8

(51) Int. Cl. G06F 9/50

(52) U.S. Cl. CPC G06F 9/5027

(57) ABSTRACT

Embodiments of the present disclosure relate to a method, an electronic device, and a computer program product for allocating a workload. The method includes acquiring a first state graph of a plurality of devices that run a first workload at a first time point. The method further includes updating the first state graph based on a comparison between an active value of at least one node in the first state graph and a predetermined threshold. The method further includes determining a first load state of the plurality of devices at the first time point based on an updated first state graph. The method further includes allocating a second workload to the plurality of devices at a second time point based on the first load state, where active values of nodes in the updated first state graph are greater than the predetermined threshold.

### RELATED APPLICATION

The present application claims priority to Chinese Patent Application No. 202211294804.8, filed Oct. 21, 2022, and entitled “Method, Electronic Device, and Computer Program Product for Allocating Workload,” which is incorporated by reference herein in its entirety.

### FIELD

Embodiments of the present disclosure relate to the field of computers, and more particularly, to a method, an electronic device, and a computer program product for allocating a workload.

### BACKGROUND

In recent years, multi-task processing systems have played an increasingly important role in dealing with complex tasks. A given such multi-task processing system includes a plurality of devices with computing power (referred to as “computing devices”) to deal with complex tasks. The computing devices realize multi-task processing by running different workloads. How to allocate workloads among a plurality of computing devices has become a current focus of the multi-task processing system.

### SUMMARY

Embodiments of the present disclosure provide a method, an electronic device, and a computer program product for allocating a workload.

According to a first aspect of the present disclosure, a method for allocating a workload is provided. The method includes acquiring a first state graph of a plurality of devices that run a first workload at a first time point. The method further includes updating the first state graph based on a comparison between an active value of at least one node in the first state graph and a predetermined threshold. The method further includes determining a first load state of the plurality of devices at the first time point based on an updated first state graph. The method further includes allocating a second workload to the plurality of devices at a second time point based on the first load state, where active values of nodes in the updated first state graph are greater than the predetermined threshold.

According to a second aspect of the present disclosure, an electronic device is provided. The electronic device includes at least one processor; and a memory coupled to the at least one processor and having instructions stored thereon, where the instructions, when executed by the at least one processor, cause the electronic device to perform actions including: acquiring a first state graph of a plurality of devices that run a first workload at a first time point; updating the first state graph based on a comparison between an active value of at least one node in the first state graph and a predetermined threshold; determining a first load state of the plurality of devices at the first time point based on an updated first state graph; and allocating a second workload to the plurality of devices at a second time point based on the first load state, where active values of nodes in the updated first state graph are greater than the predetermined threshold.

According to a third aspect of the present disclosure, a computer program product is provided, which is tangibly stored on a non-transitory computer-readable medium and includes machine-executable instructions, where the machine-executable instructions, when executed by a machine, cause the machine to perform steps of the method in the first aspect of the present disclosure.

### BRIEF DESCRIPTION OF THE DRAWINGS

By more detailed description of example embodiments of the present disclosure, provided herein with reference to the accompanying drawings, the above and other objectives, features, and advantages of the present disclosure will become more apparent, where identical reference numerals generally represent identical components in the example embodiments of the present disclosure.

FIG. 1 illustrates a schematic diagram of an example environment in which a device and/or a method according to embodiments of the present disclosure can be implemented;

FIG. 2 illustrates a flow chart of a method for allocating a workload according to an embodiment of the present disclosure;

FIG. 3 illustrates a schematic diagram of a process for updating a state graph according to an embodiment of the present disclosure;

FIG. 4 illustrates a schematic diagram of a system for allocating a workload according to an embodiment of the present disclosure;

FIG. 5 illustrates a flow chart of a method for training a policy model according to an embodiment of the present disclosure.

FIG. 6 illustrates a schematic diagram of an architecture for training a policy model according to an embodiment of the present disclosure; and

FIG. 7 illustrates a block diagram of an example device suitable for implementing embodiments of the present disclosure.

In the drawings, identical or corresponding numerals represent identical or corresponding parts.

### DETAILED DESCRIPTION

Embodiments of the present disclosure will be described in more detail below with reference to the accompanying drawings. Although the accompanying drawings show some embodiments of the present disclosure, it should be understood that the present disclosure can be implemented in various forms, and should not be construed as being limited to the embodiments stated herein. Rather, these embodiments are provided for understanding the present disclosure more thoroughly and completely. It should be understood that the accompanying drawings and embodiments of the present disclosure are for illustrative purposes only, and are not intended to limit the protection scope of the present disclosure.

In the description of embodiments of the present disclosure, the term “include” and similar terms thereof should be understood as open-ended inclusion, that is, “including but not limited to.” The term “based on” should be understood as “based at least in part on.” The term “an embodiment” or “the embodiment” should be understood as “at least one embodiment.” The terms “first,” “second,” and the like may refer to different or identical objects. Other explicit and implicit definitions may also be included below.

In recent years, multi-task processing systems have played an increasingly important role in dealing with complex tasks. A given such multi-task processing system includes a plurality of devices with computing power (referred to as “computing devices”) to deal with complex tasks. The computing devices realize multi-task processing by running different workloads. Different workload allocation mechanisms can make the computing devices run different workloads with different running times and the like. How to allocate workloads among a plurality of computing devices to make the computing devices in the multi-task processing system achieve the shortest computing time based on such allocation so as to efficiently complete the complex tasks has become a current focus of the multi-task processing system.

To solve at least the above and other potential problems, an embodiment of the present disclosure provides a method for allocating a workload. The method includes acquiring a first state graph of a plurality of devices that run a first workload at a first time point. The method further includes updating the first state graph based on a comparison between an active value of at least one node in the first state graph and a predetermined threshold. The method further includes determining a first load state of the plurality of devices at the first time point based on an updated first state graph. The method further includes allocating a second workload to the plurality of devices at a second time point based on the first load state, where active values of nodes in the updated first state graph are greater than the predetermined threshold. With the method for allocating a workload according to embodiments of the present disclosure, there is no need to transfer information of the nodes with low activity to a next processing stage for generating state information, which can greatly save computing resources and improve computing efficiency and speed. In addition, the method for allocating a workload according to embodiments of the present disclosure is performed by, for example, a policy model obtained based on reinforcement learning, so as to achieve efficient and flexible workload allocation results.

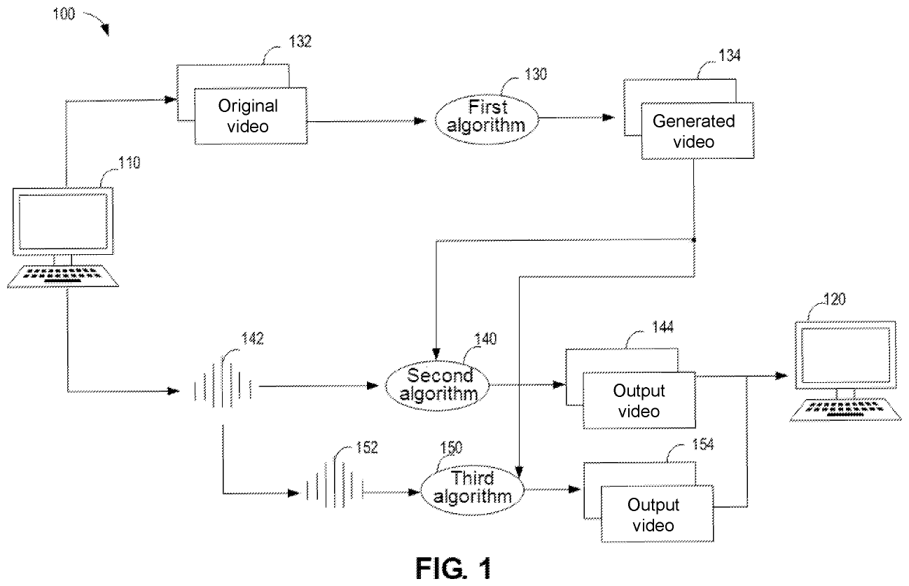

Embodiments of the present disclosure will be further described in detail with reference to the accompanying drawings below. FIG. 1 is a schematic diagram of an example environment in which embodiments of the present disclosure can be implemented.

In the example illustrated in FIG. 1, a multi-task system 100 is shown. The multi-task system 100 may be configured to generate and play virtual images. Multi-task system 100 in FIG. 1 includes computing device 110 and computing device 120. Computing device 110 may be configured to acquire original video 132 including a target image, for example, a video including a human face. Computing device 110 may further acquire original audio 142 corresponding to original video 132. In addition, in order to provide more convenience for a user, the computing device 110 may further translate original audio 142 and acquire translated audio 152. For example, when a language in acquired original audio 142 is English, computing device 110 may translate original audio 142 and acquire translated audio 152. A target language of translated audio 152 is illustratively Chinese.

In an embodiment, acquired original video 132, original audio 142, and translated audio 152 may be processed by three algorithms respectively: first algorithm 130; second algorithm 140 and third algorithm 150. Specifically, first algorithm 130 is used to generate a virtual image according to the target image in original video 132 and obtain generated video 134 with the virtual image. Second algorithm 140 may receive generated video 134, and adjust a lip movement of the virtual image in generated video 134 according to original audio 142, so as to make output video 144 realize synchronization between the lips and the audio. Similarly, third algorithm 150 may receive generated video 134, and adjust a lip movement of the virtual image in generated video 134 according to translated audio 152, so as to make output video 154 realize synchronization between the lips and the audio. Computing device 120 may play output video 144 and/or output video 154 on demand.

Although not shown, it may be understood that first algorithm 130, second algorithm 140, and third algorithm 150 may be executed by a plurality of computing devices. Computing device 110 or another computing device may allocate workloads to a plurality of computing devices, so as to execute first algorithm 130, second algorithm 140, and third algorithm 150 with lower consumption of computing resources and in a more efficient manner. In an embodiment, the method includes acquiring a first state graph of a plurality of devices that run a first workload at a first time point. The method further includes updating the first state graph based on a comparison between an active value of at least one node in the first state graph and a predetermined threshold. The method further includes determining a first load state of the plurality of devices at the first time point based on an updated first state graph. The method further includes allocating a second workload to the plurality of devices at a second time point based on the first load state, where active values of nodes in the updated first state graph are greater than the predetermined threshold. With the method for allocating a workload according to embodiments of the present disclosure, there is no need to transfer information of the nodes with low activity to a next processing stage for generating state information, which can greatly save computing resources and improve computing efficiency and speed. In addition, the method for allocating a workload according to this embodiment of the present disclosure may be performed by, for example, a model obtained based on reinforcement learning, so as to achieve efficient and flexible workload allocation results.

The method for allocating a workload applied to example multi-task system 100 shown in FIG. 1 may be performed by a computing device (not shown). The computing device includes, but is not limited to, a personal computer, a server computer, a handheld or laptop device, a mobile device (such as a mobile phone, a personal digital assistant (PDA), and a media player), a multi-processor system, a consumer electronic product, a wearable electronic device, an intelligent home device, a minicomputer, a mainframe computer, an edge computing device, a distributed computing environment including any of the above systems or devices, etc.

Although only multi-task system 100 taking generation of the virtual image as an example is illustrated in FIG. 1, it should be appreciated by persons skilled in the art that the method for allocating a workload according to this embodiment of the present disclosure can be applied to other scenarios, and the workload can be allocated in the other scenarios to enable a plurality of computing devices to operate in an efficient manner and with low power consumption. The method for allocating a workload according to this embodiment of the present disclosure is not limited in the present disclosure.

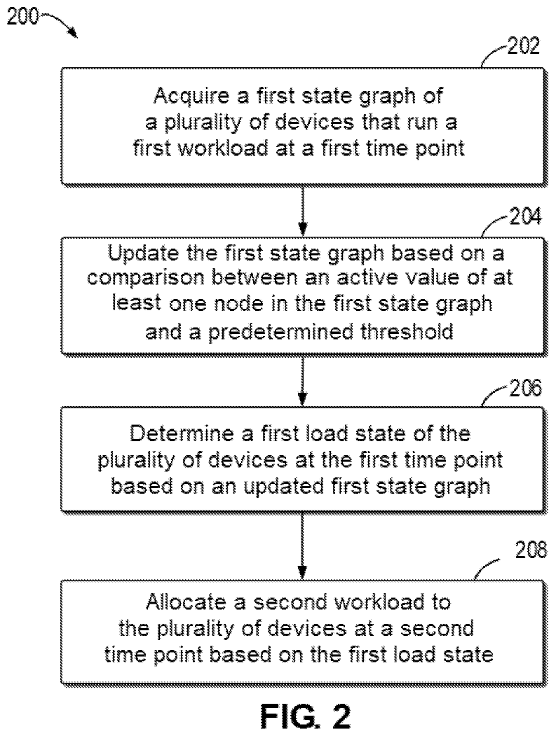

A block diagram of example multi-task system 100 in which embodiments of the present disclosure can be implemented has been described above with reference to FIG. 1. A flow chart of method 200 for allocating a workload according to an embodiment of the present disclosure will be described below with reference to FIG. 2. Method 200 may be performed at the computing device (not shown) shown in FIG. 1 and at any suitable computing device.

At block 202, a computing device acquires a first state graph of a plurality of devices that run a first workload at a first time point. A state graph is a graph that includes a set of nodes and edges among the nodes. In the state graph, each node may represent execution of operations of a corresponding algorithm. For example, each node may represent how many operations have been executed and how many operations have not been executed in the corresponding algorithm. Accordingly, an edge between two nodes represents a dependency between two algorithms.

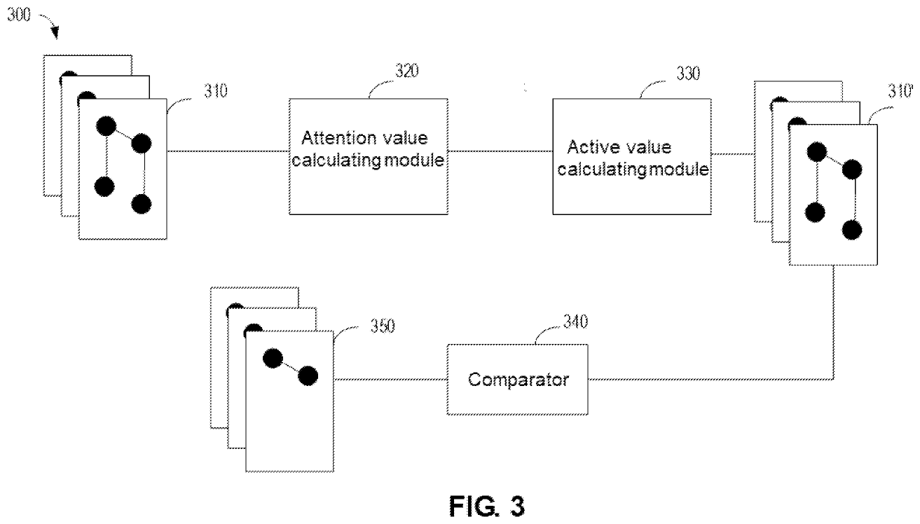

At block 204, the computing device updates the first state graph based on a comparison between an active value of at least one node in the first state graph and a predetermined threshold. The active value of a node may be obtained based on an attention value between two nodes and a propagated value of the node. A specific process of updating the state graph will be described below with reference to FIG. 3.

At block 206, the computing device determines a first load state of the plurality of devices at the first time point based on an updated first state graph. In an embodiment, the computing device may input the updated first state graph to a graph neural network model, and the graph neural network model outputs the first load state of the plurality of devices at the first time point.

At block 208, the computing device allocates a second workload to the plurality of devices at a second time point based on the first load state, where active values of nodes in the updated first state graph are greater than the predetermined threshold.

With method 200 for allocating a workload according to this embodiment of the present disclosure, there is no need to transfer information of the nodes with low activity to a next processing stage for generating state information, and only information of the nodes with high active values is transferred to the next processing stage, which can greatly save computing resources and improve computing efficiency and speed without affecting accuracy of allocation of the workload.

Process 300 for updating a state graph according to an embodiment of the present disclosure will be described below with reference to FIG. 3. It may be understood that method 200 may be performed at the computing device (not shown) shown in FIG. 1 and at any suitable computing device.

As shown in FIG. 3, in process 300, a computing device acquires first state graph 310 of a plurality of devices that run a first workload at a first time point. As described above, in the state graph, each node may represent execution of operations of a corresponding algorithm. For example, each node may represent how many operations have been executed and how many operations have not been executed in the corresponding algorithm. Accordingly, an edge between two nodes represents a dependency between two algorithms. It may be understood that the example of first state graph 310 is only schematic. Depending on an actual situation, the state graph may include different numbers of nodes and different dependencies among the nodes.

In process 300, the computing device may calculate an attention value between two nodes in the state graph through attention value calculating module 320. Specifically, for node vᵢ, node vᵢ, and edge eₖ between node vᵢ and node vⱼ, attention value calculating module 320 may calculate a score of edge eₖ between node vᵢ and node vⱼ according to the following Equation (1):

s_{i,jk}=LeakyReLU(vₐ tanh(Wₕvᵢ∥Wₜvᵢ∥Wᵣeₖ)) (1)

where Wₕ, Wₜ, and Wᵣ are weights that can be obtained by training. By use of Equation (1), the score of each edge in state graph 310 can be obtained. Attention value calculating module 320 may obtain, based on the calculated score, attention value aᵢⱼ between every two nodes based on Equation (2):

aᵢⱼ=softmax(s_{i,j,k}) (2)

In an embodiment, the computing device may calculate an active value of each node in the state graph according to the calculated attention value between every two nodes through active value calculating module 330. Specifically, active value calculating module 330 may calculate a propagated value between a node and a target node from an attenuation coefficient with Equation (3). The target node may be adjacent to the node. The target node may also cross a plurality of nodes to be adjacent to the node. Moreover, attenuation coefficient θₖ may be an N^{th} power of initial attenuation coefficient θ₀, where N denotes a distance between the node and the target node (counted as the number of nodes). When computing the propagated value, active value calculating module 330 may determine the propagated value based on Equation (3):

Pᵢⱼ=θₖa₀ (3)

where Pᵢⱼ denotes a propagated value from node vᵢ to target node vⱼ, and θₖ denotes an attenuation coefficient from node vᵢ to target node vⱼ. Moreover, the attenuation coefficient is an N^{th} power of initial attenuation coefficient θ₀, where N denotes a distance between node vᵢ and target node vⱼ (in units of the number of nodes), and a₀ denotes an initial active value of the target node, which is, for example, 1. Taking initial attenuation coefficient θ₀ being 0.5 as an example, a propagated value between node vᵢ and adjacent node v₍ᵢ₊₁₎ is 0.5×1=0.5, and a propagated value between node vᵢ and node v₍ᵢ₊₂₎ which is two nodes away from node vᵢ is 0.5²×1=0.25.

Based on the calculated propagated value and the attention value between two nodes, active value calculating module 330 may obtain the active value of each node based on Equation (4):

$${a}_{j} = {a}_{j , 0} + {\sum }_{i = 0}^{j} {P}_{i j} {a}_{i j} \qquad ( 4 )$$

where aᵢⱼ denotes the attention value between every two nodes, and a_{j,0} denotes an initial active value of node vⱼ. Thus, active value calculating module 330 may obtain the active value of each node based on Equation (4). Thus, the computing device may obtain state graph 310′ with the active value of each node. In other words, the active value of each node in state graph 310′ is obtained by performing computations as previously described.

In an embodiment, the computing device may input the active value of each node in state graph 310′ to comparator 340, and the comparator 340 compares the active value of each node with the predetermined threshold. In an embodiment, the computing device may update the state graph based on a comparison result and acquire updated state graph 350. In an embodiment, the computing device may filter out nodes whose active values are less than the predetermined threshold from first state graph 310 (for example, delete the nodes from first state graph 310), so as to obtain updated state graph 350. In other words, active values of nodes in updated state graph 350 are all greater than the predetermined threshold. Half of the nodes depicted in first state graph 310 are filtered out from illustrated updated state graph 350. It may be understood that updated state graph 350 is only illustrative, and the computing device may set different predetermined thresholds according to requirements and application scenarios, so as to filter out different numbers of nodes and obtain updated state graph 350.

Thus, the number of nodes in updated state graph 350 is smaller than the number of nodes in first state graph 310. Therefore, when the graph neural network model processes updated state graph 350, consumption of computing resources of the computing device can be significantly reduced. This is because the graph neural network model in the computing device only needs to perform calculations for the remaining nodes in updated state graph 350. Thus, the computing resources are significantly saved, and the computing efficiency and speed can be significantly improved.

In an embodiment, the computing device may further acquire a second state graph of the plurality of devices that run the second workload at the second time point. The second state graph is a graph that includes a set of nodes and edges among the nodes. For example, the second state graph may represent operations that have been performed and operations that have not been performed in the algorithm corresponding to each node, and an edge between two nodes represents a dependency between the two nodes. The computing device may update the second state graph based on a comparison between active values of various nodes in the second state graph and the predetermined threshold. In an embodiment, the active value of a node may be obtained based on an attention value between two nodes and a propagated value of the node. The computing device may determine a second load state of the plurality of devices at the second time point based on an updated second state graph. For example, the computing device may input the updated second state graph to the graph neural network model, and the graph neural network model outputs the second load state of the plurality of devices at the second time point. The computing device may allocate a third workload to the plurality of devices at a third time point based on the second load state, where active values of nodes in the updated second state graph are greater than the predetermined threshold. Specific processes of computing the active values of the nodes and updating the state graph can be understood by referring to process 300 shown in FIG. 3, which will not be described in detail again here for the sake of brevity.

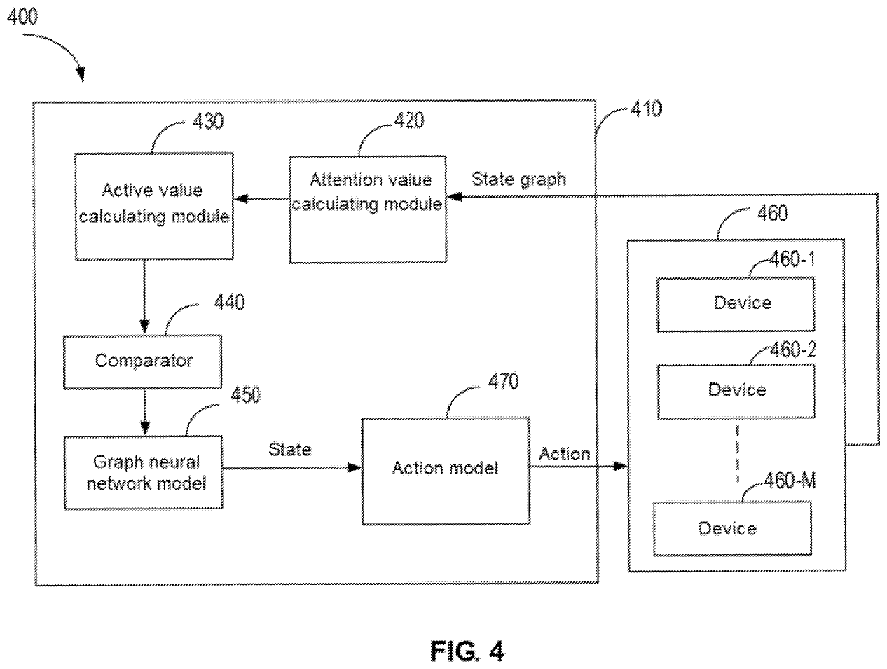

In an embodiment, the method for allocating a workload according to this embodiment of the present disclosure may be performed by a computing device. More specifically, a policy model may be implemented in the computing device, and the policy model may perform the method for allocating a workload (for example, method 200) according to this embodiment of the present disclosure. In an embodiment, the policy model may be trained based on reinforcement learning. As shown in FIG. 4, a schematic diagram of workload allocation system 400 according to an embodiment of the present disclosure is shown. A specific process of allocating a load by workload allocation system 400 will be introduced below with reference to FIG. 4.

Workload allocation system 400 in FIG. 4 includes policy model 410 and a plurality of devices 460-1, 460-2, . . . , and 460-M (where M is a positive integer greater than 1), with the plurality of devices being collectively denoted as devices 460. Workload allocation system 400 is configured to allocate a workload to a plurality of devices, so that running times during which the plurality of devices run the workload can be optimized.

In an embodiment, policy model 410 includes attention value calculating module 420, active value calculating module 430, comparator 440, and graph neural network model 450 as described above, as well as action model 470. In an embodiment, action model 470 may determine a load allocation action at a current time point based on acquired state information at a previous time point.

In an embodiment, the computing device may acquire first state graph G1 based on a condition in which the plurality of devices run a first workload based on first time point T1. Attention value calculating module 420 calculates an attention value between two nodes in first state graph G1. Active value calculating module 430 determines active values of various nodes in first state graph G1 according to the attention value calculated by attention value calculating module 420. Comparator 440 compares the active values of the various nodes in first state graph G1 with a predetermined threshold, so as to filter out the nodes whose active values are less than the predetermined threshold to update state graph G1, and obtains updated state graph G11. Updated state graph G11 may be processed by graph neural network model 450. Graph neural network model 450 may output first load state S1 of the plurality of devices at first time point T1. Action model 470 may output action information based on first load state S1, so as to allocate a second workload among the plurality of devices at second time point T2, and thus running times during which the plurality of devices run the second workload can be optimized. Workload allocation system 400 can iteratively perform the above operations, so as to optimize the running times for the plurality of devices in the case of multi-task processing.

With the method for allocating a workload according to this embodiment of the present disclosure, there is no need to transfer information of the nodes with low activity to a next processing stage for generating state information, but only the nodes whose active values are greater than the predetermined threshold are transferred to the graph neural network model, which can greatly save computing resources and improve computing efficiency and speed.

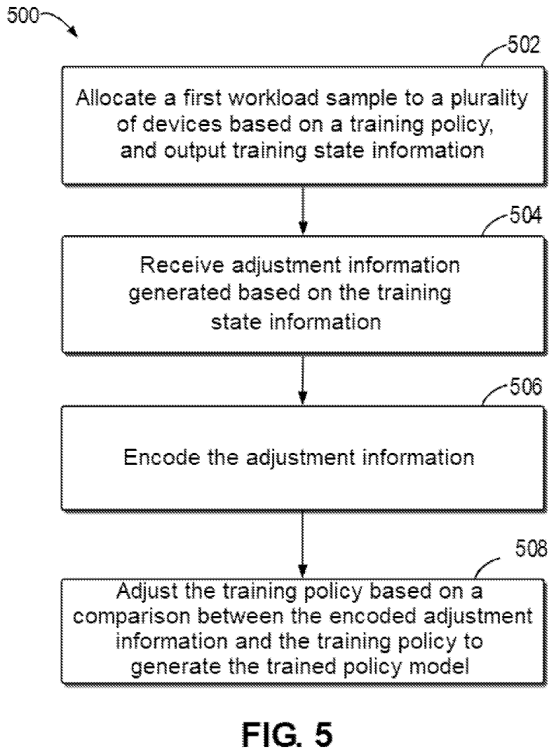

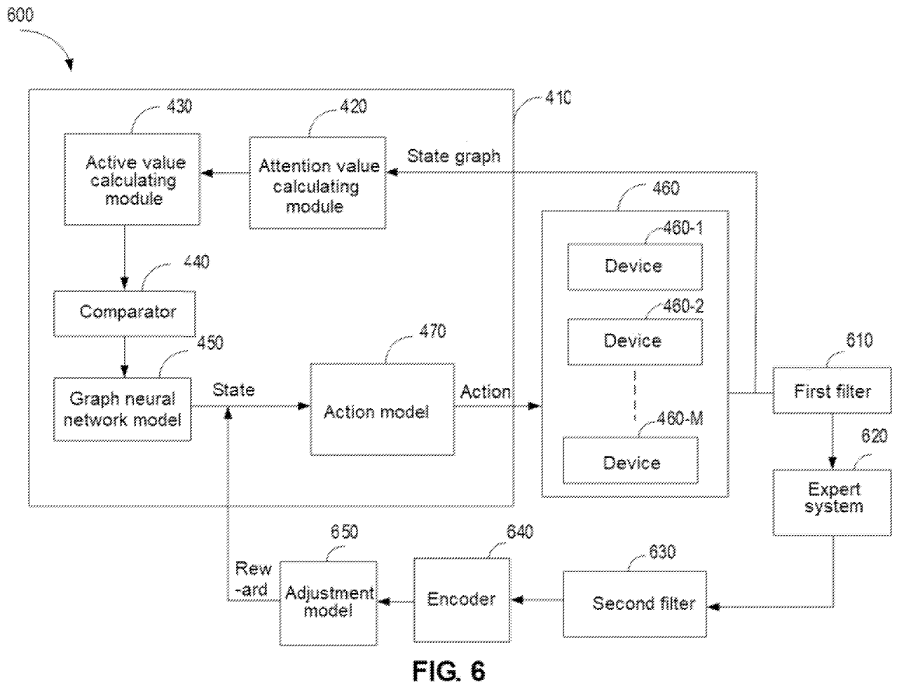

The method for allocating a workload according to this embodiment of the present disclosure may be performed by, for example, a model obtained based on reinforcement learning, so as to achieve efficient and flexible workload allocation results. An example implementation in which the policy model is trained will be described below with reference to FIG. 5 to FIG. 6. It may be understood that FIG. 5 to FIG. 6 are merely examples, and persons skilled in the art can add or combine some steps or modify some steps according to allocation requirements and application scenarios of the workload, which are not limited in embodiments of the present disclosure.

FIG. 5 illustrates training method 500 for a policy model according to an embodiment of the present disclosure. The training method in FIG. 5 may be performed in any device that includes the computing device performing method 200. Although a training process of the policy model is described below by taking a “training device” as an example, it may be understood that the training device includes a computing device that performs the method for allocating a workload according to embodiments of the present disclosure. The training device may further include other computing devices different from the computing device that performs the method for allocating a workload according to embodiments of the present disclosure. The computing device may obtain a trained policy model to accordingly perform the method for allocating a workload according to embodiments of the present disclosure, for example, method 200 in FIG. 2. Training method 500 in FIG. 5 will be described below with reference to training system 600 for training a policy model in FIG. 6. Elements in FIG. 6 that are the same as those in FIG. 4 are represented with identical reference numerals.

At block 502, the training device may allocate a first workload sample to a plurality of devices 460-1, 460-2, . . . , and 460-M based on a training policy, and output training state information. In an embodiment, the training device may have training policy pyᵢ at time point tᵢ. The training device may allocate the first workload sample to the plurality of devices 460-1, 460-2, . . . , and 460-M based on training policy pyᵢ, and output training state information Sₜᵢ based on a condition in which the plurality of devices 460-1, 460-2, . . . , and 460-M run the first workload sample. A process of outputting training state information Sₜᵢ may be based on techniques similar to those depicted in FIG. 3 and FIG. 4, in which graph neural network model 450 processes the state graph and outputs training state information Sₜᵢ. Moreover, graph neural network model 450 may output, according to process 300 shown in FIG. 3, the training state information based on an updated state graph from which the nodes have been filtered out. Details will not be described again here for the sake of brevity.

At block 504, the training device may receive adjustment information generated based on the training state information. In an embodiment, information (for example, state information of the devices that run the workload) provided as output by the plurality of devices 460-1, 460-2, . . . , and 460-M may be input to first filter 610, and first filter 610 may filter the received information, for example, filter out exception information. The exception information may include information that is not helpful for expert system 620 to generate adjustment information, so as to reduce the consumption of computing resources of expert system 620 and improve the training speed and efficiency.

In an embodiment, expert system 620 may generate the adjustment information based on the filtered information. The adjustment information may be used to adjust a reward for policy model 410, so as to achieve the optimization of the policy model. In an embodiment, the adjustment information may include a predetermined normal form generated by expert system 620 based on the received information. The predetermined normal form may represent preferred policy PYₜₕᵢ in light of the information. In an embodiment, expert system 620 may include a trained expert system model configured to generate the predetermined normal form based on the received information. In another embodiment, expert system 620 may further receive a predetermined normal form set by a user based on the received information. A specific implementation for expert system 620 is not limited in the present disclosure.

At block 506, the training device may encode the adjustment information. The training device may encode the received adjustment information through encoder 640. Encoder 640 may encode the adjustment information by using a known encoding technology and a future developed encoding technology. An encoding implementation adopted by encoder 640 is not limited in the present disclosure.

At block 508, the training device may adjust training policy py₍ᵢ₊₁₎ at next time point t₍ᵢ₊₁₎ based on a comparison between encoded adjustment information PYₜₕᵢ and training policy pyᵢ, and may generate a trained policy model based on this. In an embodiment, adjustment model 650 in the training device may calculate distance dᵢ between adjustment information PYₜₕᵢ and training policy pyᵢ, and adjust at an inverse ratio, based on the calculated distance dᵢ, a reward for allocating a second workload sample to the devices at next time point (for example, time point t₍ᵢ₊₁₎). In other words, the larger the distance dᵢ is, the smaller the reward is set. The smaller the distance dᵢ is, the larger the reward is set. For example, when adjustment model 650 determines that distance dᵢ between adjustment information PYₜₕᵢ and training policy pyᵢ becomes smaller at time point tᵢ, adjustment model 650 sets an increased reward. When adjustment model 650 determines that distance dᵢ between adjustment information PYₜₕᵢ and training policy pyᵢ becomes larger at time point tᵢ, adjustment model 650 sets a reduced reward. Adjustment model 650 may calculate distance dᵢ between adjustment information PYₜₕᵢ and training policy pyᵢ based on any appropriate implementation. An implementation in which distance dᵢ is calculated is not limited in this embodiment of the present disclosure.

In addition, as shown in FIG. 6, training system 600 in FIG. 6 may further include second filter 630. Second filter 630 may be configured to further filter the information output by expert system 620. For example, second filter 630 may filter out information that is not related to the reward adjusted by adjustment model 650, which reduces the amount of information processed by encoder 640 and adjustment model 650, and can further reduce the consumption of computing resources of the system and further significantly improve the training speed and efficiency of the policy model.

In an embodiment, action model 470 may update the training policy based on the adjusted reward, and obtain updated training policy py₍ᵢ₊₁₎. Action model 470 may output an action based on updated training policy py₍ᵢ₊₁₎, so that the second workload sample can be allocated to the plurality of devices 460-1, 460-2, . . . , and 460-M at time point t₍ᵢ₊₁₎. The training device may acquire training state information Sₜ₍ᵢ₊₁₎ of the plurality of devices 460-1, 460-2, . . . , and 460-M at time point t₍ᵢ₊₁₎. The training device may receive adjustment information generated based on training state information Sₜ₍ᵢ₊₁₎. The training device may further encode the adjustment information, and adjust training policy py₍ᵢ₊₂₎ at next time point t₍ᵢ₊₂₎ based on a comparison between encoded adjustment information PYₜₕ₍ᵢ₊₁₎ and training policy py₍ᵢ₊₁₎. Specifically, when adjustment model 650 in the training device determines that distance d₍ᵢ₊₁₎ between adjustment information PYₜₕ₍ᵢ₊₁₎ and training policy py₍ᵢ₊₁₎ becomes smaller at time point t₍ᵢ₊₁₎, adjustment model 650 sets an increased reward. When adjustment model 650 determines that distance d₍ᵢ₊₁₎ between adjustment information PYₜₕ₍ᵢ₊₁₎ and training policy py₍ᵢ₊₁₎ becomes larger at time point t₍ᵢ₊₁₎, adjustment model 650 sets a reduced reward. Thus, action model 470 can update training policy py₍ᵢ₊₂₎ at next time point t₍ᵢ₊₂₎ based on the adjusted reward. Similarly, the training device may iteratively perform the above operations multiple times, until the updated training policy enables the plurality of devices to obtain optimized running times when running the workload sample, so as to obtain the trained policy model.

It may be understood that, although the policy model is trained by taking a running time as an example in the above descriptions, a parameter type for a loss function can be set according to an application scenario and an actual requirement of the policy model, for example, an optimized resource utilization rate, and the trained policy model can be obtained with the above similar iterative training method.

Based on the method for allocating a workload according to embodiments of the present disclosure, there is no need to transfer the nodes with low active values to the graph neural network model for processing, but only the nodes whose active value are greater than the predetermined threshold need to be transferred to the graph neural network model for processing, which can significantly reduce the consumption of computing resources and greatly improve computing time and computing efficiency. In addition, the policy model used in embodiments of the present disclosure can be obtained through reinforcement learning, and during the reinforcement learning, by using a filter, the consumption of computing resources of the system can be further reduced, and the training speed and efficiency can be further improved. In addition, the training process can also be accelerated by using an expert system in embodiments of the present disclosure, so as to improve the training efficiency and further reduce training costs.

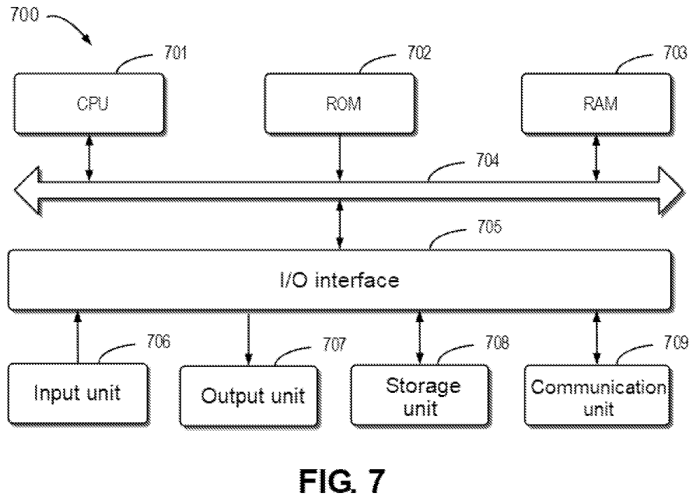

FIG. 7 shows a block diagram of example device 700 that can be configured to implement embodiments of the present disclosure. Computing devices for performing the methods according to embodiments of the present disclosure may be implemented using device 700. As shown in the figure, device 700 includes central processing unit (CPU) 701 that may perform various appropriate actions and processing according to computer program instructions stored in read-only memory (ROM) 702 or computer program instructions loaded from storage unit 708 to random access memory (RAM) 703. Various programs and data required for the operation of device 700 may also be stored in RAM 703. CPU 701, ROM 702, and RAM 703 are connected to each other through bus 704. Input/Output (I/O) interface 705 is also connected to bus 704.

A plurality of components in device 700 are connected to I/O interface 705, including: input unit 706, such as a keyboard and a mouse; output unit 707, such as various types of displays and speakers; storage unit 708, such as a magnetic disk and an optical disc; and communication unit 709, such as a network card, a modem, and a wireless communication transceiver. Communication unit 709 allows device 700 to exchange information/data with other devices via a computer network, such as the Internet, and/or various telecommunication networks.

The various processes and processing described above, such as method 200 for allocating a workload and the related processes (e.g., training method 500), may be performed by CPU 701. For example, in some embodiments, method 200 for allocating a workload and the related processes (e.g., training method 500) may be implemented as a computer software program that is tangibly contained in a machine-readable medium, such as storage unit 708. In some embodiments, part or all of the computer program may be loaded and/or installed onto device 700 via ROM 702 and/or communication unit 709. When the computer program is loaded into RAM 703 and executed by CPU 701, one or more actions of method 200 for allocating a workload and the related processes (e.g., training method 500) described above may be performed.

Illustrative embodiments of the present disclosure include a method, an apparatus, a system, and/or a computer program product. The computer program product may include a computer-readable storage medium on which computer-readable program instructions for performing various aspects of the present disclosure are loaded.

The computer-readable storage medium may be a tangible device that may retain and store instructions used by an instruction-executing device. For example, the computer-readable storage medium may be, but is not limited to, an electric storage device, a magnetic storage device, an optical storage device, an electromagnetic storage device, a semiconductor storage device, or any suitable combination of the foregoing. More specific examples (a non-exhaustive list) of the computer-readable storage medium include: a portable computer disk, a hard disk, a RAM, a ROM, an erasable programmable read-only memory (EPROM or flash memory), a static random access memory (SRAM), a portable compact disc read-only memory (CD-ROM), a digital versatile disc (DVD), a memory stick, a floppy disk, a mechanical encoding device, for example, a punch card or a raised structure in a groove with instructions stored thereon, and any suitable combination of the foregoing. The computer-readable storage medium used herein is not to be interpreted as transient signals per se, such as radio waves or other freely propagating electromagnetic waves, electromagnetic waves propagating through waveguides or other transmission media (e.g., light pulses through fiber-optic cables), or electrical signals transmitted through electrical wires.

The computer-readable program instructions described herein may be downloaded from a computer-readable storage medium to various computing/processing devices or downloaded to an external computer or external storage device over a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in each computing/processing device.

The computer program instructions for executing the operation of the present disclosure may be assembly instructions, instruction set architecture (ISA) instructions, machine instructions, machine-dependent instructions, microcode, firmware instructions, status setting data, or source code or object code written in any combination of one or a plurality of programming languages, the programming languages including object-oriented programming languages such as Smalltalk and C++, and conventional procedural programming languages such as the C language or similar programming languages. The computer-readable program instructions may be executed entirely on a user computer, partly on a user computer, as a stand-alone software package, partly on a user computer and partly on a remote computer, or entirely on a remote computer or a server. In a case where a remote computer is involved, the remote computer may be connected to a user computer through any kind of networks, including a local area network (LAN) or a wide area network (WAN), or may be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions so as to implement various aspects of the present disclosure.

Various aspects of the present disclosure are described herein with reference to flow charts and/or block diagrams of the method, the apparatus (system), and the computer program product according to embodiments of the present disclosure. It should be understood that each block of the flow charts and/or the block diagrams and combinations of blocks in the flow charts and/or the block diagrams may be implemented by computer-readable program instructions.

These computer-readable program instructions may be provided to a processing unit of a general-purpose computer, a special-purpose computer, or a further programmable data processing apparatus, thereby producing a machine, such that these instructions, when executed by the processing unit of the computer or the further programmable data processing apparatus, produce means for implementing functions/actions specified in one or a plurality of blocks in the flow charts and/or block diagrams. These computer-readable program instructions may also be stored in a computer-readable storage medium, and these instructions cause a computer, a programmable data processing apparatus, and/or other devices to operate in a specific manner; and thus the computer-readable medium having instructions stored includes an article of manufacture that includes instructions that implement various aspects of the functions/actions specified in one or a plurality of blocks in the flow charts and/or block diagrams.

The computer-readable program instructions may also be loaded to a computer, a further programmable data processing apparatus, or a further device, so that a series of operating steps may be performed on the computer, the further programmable data processing apparatus, or the further device to produce a computer-implemented process, such that the instructions executed on the computer, the further programmable data processing apparatus, or the further device may implement the functions/actions specified in one or a plurality of blocks in the flow charts and/or block diagrams.

The flow charts and block diagrams in the drawings illustrate the architectures, functions, and operations of possible implementations of the systems, methods, and computer program products according to various embodiments of the present disclosure. In this regard, each block in the flow charts or block diagrams may represent a module, a program segment, or part of an instruction, the module, program segment, or part of an instruction including one or a plurality of executable instructions for implementing specified logical functions. In some alternative implementations, functions marked in the blocks may also occur in an order different from that marked in the accompanying drawings. For example, two successive blocks may actually be executed in parallel substantially, and sometimes they may also be executed in a reverse order, which depends on the involved functions. It should be further noted that each block in the block diagrams and/or flow charts as well as a combination of blocks in the block diagrams and/or flow charts may be implemented using a dedicated hardware-based system that executes specified functions or actions, or using a combination of special hardware and computer instructions.

Various embodiments of the present disclosure have been described above. The above description is illustrative, rather than exhaustive, and is not limited to the disclosed various embodiments. Numerous modifications and alterations will be apparent to persons of ordinary skill in the art without departing from the scope and spirit of the illustrated various embodiments. The selection of terms as used herein is intended to best explain the principles and practical applications of the various embodiments and their associated improvements, so as to enable persons of ordinary skill in the art to understand the embodiments disclosed herein.

What is claimed is:

1. A method for allocating a workload, comprising:
acquiring a first state graph of a plurality of devices that run a first workload at a first time point;
updating the first state graph based on a comparison between an active value of at least one node in the first state graph and a predetermined threshold; and
determining a first load state of the plurality of devices at the first time point based on an updated first state graph; and
allocating a second workload to the plurality of devices at a second time point based on the first load state,
wherein active values of nodes in the updated first state graph are greater than the predetermined threshold.

2. The method according to claim 1, wherein the first time point is earlier than the second time point.

3. The method according to claim 1, wherein determining a first load state comprises:
determining the first load state by a graph neural network model based on the updated first state graph.

4. The method according to claim 1, wherein updating the first state graph comprises:
determining, based on the comparison, that the active value is less than the predetermined threshold; and
acquiring the updated first state graph by deleting the at least one node from the first state graph,
wherein the active values of the nodes in the updated first state graph are greater than the predetermined threshold.

5. The method according to claim 1, further comprising:
setting an initial active value of the at least one node to a specified value;
determining a propagated value between the at least one node and a target node based on an attenuation coefficient; and
determining the active value of the at least one node based on the propagated value and a score of an edge between the at least one node and the target node.

6. The method according to claim 1, further comprising:
acquiring a second state graph of the plurality of devices at the second time point; and
acquiring a second load state based on the second state graph;
wherein the first load state comprises a first running time during which the plurality of devices run the first workload at the first time point, and the second load state comprises a second running time during which the plurality of devices run the second workload at the second time point.

7. The method according to claim 1, wherein the method is performed by a policy model, the policy model being trained through steps comprising:
allocating a first workload sample to the plurality of devices based on a training policy, and outputting training state information;
receiving adjustment information generated based on the training state information;
encoding the adjustment information; and
adjusting the training policy based on a comparison between the encoded adjustment information and the training policy to generate the trained policy model.

8. The method according to claim 7, wherein adjusting the training policy comprises:
determining a distance between the encoded information and the training policy;
adjusting at an inverse ratio, based on the distance, a reward for allocating the first workload sample to the plurality of devices; and
updating the training policy based on the adjusted reward.

9. The method according to claim 7, wherein the steps further comprise:
filtering the training state information to remove exception information,
wherein the adjustment information is generated based on the filtered training state information.

10. An electronic device, comprising:
at least one processor; and
a memory coupled to the at least one processor and having instructions stored thereon, wherein the instructions, when executed by the at least one processor, cause the electronic device to perform actions comprising:
acquiring a first state graph of a plurality of devices that run a first workload at a first time point;
updating the first state graph based on a comparison between an active value of at least one node in the first state graph and a predetermined threshold; and
determining a first load state of the plurality of devices at the first time point based on an updated first state graph; and
allocating a second workload to the plurality of devices at a second time point based on the first load state,
wherein active values of nodes in the updated first state graph are greater than the predetermined threshold.

11. The electronic device according to claim 10, wherein the first time point is earlier than the second time point.

12. The electronic device according to claim 10, wherein determining a first load state comprises:
determining the first load state by a graph neural network model based on the updated first state graph.

13. The electronic device according to claim 10, wherein updating the first state graph comprises:
determining, based on the comparison, that the active value is less than the predetermined threshold; and
acquiring the updated first state graph by deleting the at least one node from the first state graph,
wherein the active values of the nodes in the updated first state graph are greater than the predetermined threshold.

14. The electronic device according to claim 10, wherein the instructions, when executed by the at least one processor, further cause the electronic device to perform actions comprising:
setting an initial active value of the at least one node to a specified value;
determining a propagated value between the at least one node and a target node based on an attenuation coefficient; and
determining the active value of the at least one node based on the propagated value and a score of an edge between the at least one node and the target node.

15. The electronic device according to claim 10, wherein the instructions, when executed by the at least one processor, further cause the electronic device to perform actions comprising:
acquiring a second state graph of the plurality of devices at the second time point; and
acquiring a second load state based on the second state graph;
wherein the first load state comprises a first running time during which the plurality of devices run the first workload at the first time point, and the second load state comprises a second running time during which the plurality of devices run the second workload at the second time point.

16. The electronic device according to claim 10, wherein the instructions, when executed by the at least one processor, further cause the electronic device to perform training actions to train a policy model, the training actions comprising:
allocating a first workload sample to the plurality of devices based on a training policy, and outputting training state information;
receiving adjustment information generated based on the training state information;
encoding the adjustment information; and
adjusting the training policy based on a comparison between the encoded adjustment information and the training policy to generate the trained policy model.

17. The electronic device according to claim 16, wherein adjusting the training policy comprises:
determining a distance between the encoded information and the training policy;
adjusting at an inverse ratio, based on the distance, a reward for allocating the first workload sample to the plurality of devices; and
updating the training policy based on the adjusted reward.

18. The electronic device according to claim 16, wherein the training actions further comprise:
filtering the training state information to remove exception information,
wherein the adjustment information is generated based on the filtered training state information.

19. A computer program product, wherein the computer program product is tangibly stored on a non-transitory computer-readable medium and comprises machine-executable instructions, wherein the machine-executable instructions, when executed by a machine, cause the machine to perform actions comprising:
acquiring a first state graph of a plurality of devices that run a first workload at a first time point;
updating the first state graph based on a comparison between an active value of at least one node in the first state graph and a predetermined threshold; and
determining a first load state of the plurality of devices at the first time point based on an updated first state graph; and
allocating a second workload to the plurality of devices at a second time point based on the first load state,
wherein active values of nodes in the updated first state graph are greater than the predetermined threshold.

20. The computer program product according to claim 19, wherein the machine-executable instructions, when executed by the machine, further cause the machine to perform training actions to train a policy model, the training actions comprising:
allocating a workload sample to the plurality of devices based on a training policy, and outputting training state information;
receiving adjustment information generated based on the training state information;
encoding the adjustment information; and
adjusting the training policy based on a comparison between the encoded adjustment information and the training policy to generate the trained policy model.
